(19) United States
(12) Patent Application Publication
(10) Pub. No.: US 2024/0148180 A1
(43) Pub. Date: May 9, 2024

(54) COFFEE MACHINE

(71) Applicant: JIANGSU MACCHIATO INTELLIGENT TECHNOLOGY CO., LTD., YANCHENG CITY (CN)

(72) Inventors: MING CHENG, YANCHENG CITY (CN); XINWU WANG, YANCHENG CITY (CN); CHUNLONG HU, YANCHENG CITY (CN)

(21) Appl. No.: 18/304,218

(22) Filed: Apr. 20, 2023

(30) Foreign Application Priority Data
Nov. 3, 2022 (CN) 202222922481.4

(51) Int. Cl. A47J 31/36; A47J 31/42; A47J 31/44; A47J 31/46; A47J 31/52; A47J 31/54; A47J 42/26; A47J 42/28; A47J 42/50

(52) U.S. Cl. CPC A47J 31/3614; A47J 31/3619; A47J 31/42; A47J 31/4403; A47J 31/461; A47J 31/468; A47J 31/469; A47J 31/5255; A47J 31/542; A47J 42/26; A47J 42/28; A47J 42/50

(57) ABSTRACT

The disclosure provides a coffee machine. The machine includes a main housing, wherein the main housing has: a coffee bean silo; a bean grinding assembly, wherein the bean grinding assembly is connected with a bean outlet of the coffee bean silo; a boiler piston assembly including a coffee machine boiler, a bag pressing mechanism and an ejector mechanism, wherein the coffee machine boiler is connected with a material outlet of the bean grinding assembly, the bag pressing mechanism includes a bag pressing block that is connected with a piston assembly, wherein the piston assembly can drive the bag pressing block to perform bag pressing on coffee in the coffee machine boiler, the ejector mechanism can eject a coffee cake in the coffee machine boiler after the coffee extraction is completed; a coffee grounds box; water tank; a waterway switching mechanism; and a coffee dispensing spout.

### CROSS-REFERENCE TO RELATED APPLICATION

This patent application claims the benefit and priority of Chinese Patent Application No. 202222922481.4 filed with the China National Intellectual Property Administration on Nov. 3, 2022, the disclosure of which is incorporated by reference herein in its entirety as part of the present application.

### TECHNICAL FIELD

The present disclosure relates to the technical field of a coffee machine, in particular to a coffee machine.

### BACKGROUND

A traditional fully automatic coffee machine usually uses brewing components to extract coffee. At present, a brewing mechanism employed in the fully automatic coffee machine usually uses multiple mechanical actions to flip the pressure bag. Specifically, at present, the brewing mechanism includes a coffee machine boiler and a bag pressing mechanism. A mounting bracket is arranged on the coffee machine boiler, and the bag pressing mechanism is installed on the mounting bracket. A bottom of the bag pressing mechanism is slidably connected with the coffee machine boiler through a connecting shaft, and the mounting bracket and the bag pressing mechanism thereon are driven to rotate through the rotating shaft. When a bag pressing action is required, the bag pressing mechanism needs to be rotated directly above the coffee machine boiler for pressing bag, and it is required to lock the bag pressing mechanism to this position through a locking device. The structure is too complex and assembling is difficult, and the deviation accumulation of various parts is easy to occur, resulting in functional problems such as component stuck or powder leakage, affecting the user feeling.

### SUMMARY

A purpose of the present disclosure is to provide a coffee machine, which can solve the problems existing in the prior art, simplify the brewing mechanism, and is easy to operate.

In order to achieve the above purpose, the present disclosure provides the following solutions:

The present disclosure provides a coffee machine, which includes a main housing, wherein the main housing has therein:
a coffee bean silo arranged for temporary storage of coffee beans;
a bean grinding assembly for grinding the coffee beans, wherein the bean grinding assembly is connected with a bean outlet of the coffee bean silo;
a boiler piston assembly including a coffee machine boiler, a bag pressing mechanism and an ejector mechanism, wherein the coffee machine boiler can be connected with a material outlet of the bean grinding assembly, and the coffee beans in the bean grinding assembly can enter the coffee machine boiler after having been ground, wherein the bag pressing mechanism includes a bag pressing block which is connected with a piston assembly, wherein the piston assembly can drive the bag pressing block to perform bag pressing on coffee in the coffee machine boiler, and wherein the ejector mechanism can eject a coffee cake in the coffee machine boiler after a coffee extraction is completed;
a coffee grounds box for receiving the coffee cake;
a water tank for temporary storage of water;
a waterway switching mechanism which is connected with both the coffee machine boiler and the water tank, and can deliver water to the coffee machine boiler to extract the coffee;
a coffee dispensing spout which is connected with the coffee machine boiler, and extends out of the main housing.

Preferably, the bean grinding assembly includes a motor, a reduction gear set, a connecting shaft and a knife grinding assembly, an output shaft of the motor is connected with an input gear of the reduction gear set, an output gear of the reduction gear set is connected with the connecting shaft, the knife grinding assembly is installed in the bean grinder cavity, and the knife grinding assembly includes an internal grinding knife and an external grinding knife, the internal grinding knife is coaxially mounted on a top of the connecting shaft, and a grinding gap is formed between the internal grinding knife and the external grinding knife, a shaft hole is arranged in a center of the output gear, and a bottom of the connecting shaft is installed in the shaft hole and is coaxial with the output gear, the connecting shaft and the output gear are connected by a limit mechanism arranged in an axial direction of the connecting shaft, and the limit mechanism can limit a relative circumferential rotation between the connecting shaft and the output gear and allow the output gear to move axially along the connecting shaft.

Preferably, the coffee machine boiler includes a pot body and a coffee powder silo which are arranged separately, an installing cavity is arranged at a top of the pot body, the coffee powder silo is installed in the installation cavity, the coffee powder silo is fixedly connected with the pot body through a fastener, the pot body is therein provided with a heating device and a hot water pipe, and the hot water pipe is connected with the coffee powder silo for providing hot water to the coffee powder silo, and a connection between the hot water pipe and the coffee powder silo is provided with a sealer.

Preferably, the ejector mechanism includes an ejector head and a base, the ejector head can extend into a bottom of the coffee powder silo, a bottom of the ejector head is connected with the base through a linkage mechanism; and the linkage mechanism is sleeved with a sleeve, a top of the sleeve gets stuck at the bottom of the coffee powder silo, a first elastic element is arranged between a bottom of the sleeve and a top of the base, and the linkage mechanism is a connecting rod formed integrally.

Preferably, the piston assembly includes a piston cylinder in which a piston is arranged, and the piston is slidingly sealed with the piston cylinder, a pressure chamber is formed above the piston, the pressure chamber is provided with a water inlet and a water outlet, a top of the piston is connected with a piston rod which is extended upward out of the piston cylinder and connected with the bag pressing block, and a bottom of the piston is connected with a piston spring, wherein the piston rod is slidingly sealed with a top of the piston cylinder.

Preferably, the waterway switching mechanism includes a waterway switching shell, on which a group of waterway connectors are arranged, and the waterway connectors comprise a waterway connector for piston, a waterway connector for returning water and a waterway connector for boiler, wherein the waterway connector for piston is used to pass water to the piston assembly to complete the bag pressing action, the water connector for returning water is used to return water in the piston assembly return to the waterway switching shell, the waterway connector for boiler is used to pass water to the coffee machine boiler to extract coffee; and the waterway switching shell is also connected with a water intake for connecting with the water tank, and a booster valve is provided at the water intake, and the waterway switching shell is also installed with a waterway switching assembly for switching different waterway connectors.

Preferably, the pot body is further therein provided with a steam pipe, an exit of the steam pipe is connected with a steam nozzle, and the steam nozzle is provided close to the coffee dispensing spout; and the water connectors of the waterway switching mechanism also include a steam waterway connector which is connected with the steam pipe.

Preferably, the water tank is connected with the water intake of the waterway switching shell through a water inlet pipe, and the water inlet pipe is provided with an electromagnetic pump and a flowmeter, and the flowmeter is connected with a control mechanism.

Preferably, wherein the control mechanism is a control panel, which is installed on a top of a front side of the main housing and provided with a cup volume button for controlling water output.

Preferably, the main housing is also provided with a water receiving tray at a bottom of the front side thereof, and the water receiving tray is located below the coffee dispensing spout.

The present disclosure has achieved the following beneficial technical effects over the prior art.

According to the present disclosure, the bag pressing mechanism includes a bag pressing block which is connected with the piston assembly, and the piston assembly can drive the bag pressing block to perform bag pressing on the coffee in the coffee machine boiler. Through the piston assembly driving the bag pressing block, bag pressing and brewing can be carried out in the coffee machine boiler directly, leading to largely simplifying a structure of brewing mechanism, and simple operation, lowering cost, and avoiding the original brewing mechanism from being jammed and water leaking.

### BRIEF DESCRIPTION OF THE DRAWINGS

In order to illustrate more clearly the technical solutions of embodiments of the present disclosure and the prior art, the accompanying drawings used in the embodiments will be introduced briefly below. Apparently, the accompanying drawings described below are just some examples of the present disclosure, for one of ordinary skill in the art, other drawings can also be obtained from these drawings without creative works.

FIG. 1 is a schematic diagram of a structure of a coffee machine in an embodiment of the present disclosure.

FIG. 2 is a schematic diagram of the internal structure of the coffee machine in an embodiment of the present disclosure.

FIG. 3 is a schematic structure diagram of a boiler piston assembly in an embodiment of the present disclosure.

FIG. 4 is a schematic structure diagram of a waterway switching mechanism in an embodiment of the present disclosure.

FIG. 5 is a flowchart of coffee beans inside a coffee machine in an embodiment of the present disclosure.

FIG. 6 is a flowchart of water inside the coffee machine when brewing coffee in an embodiment of the present disclosure.

FIG. 7 is a flow chart of the water inside the coffee machine when steam is produced in an embodiment of the present disclosure.

### REFERENCE NUMERALS

1 coffee bean silo, 2 water tank, 3 control panel, 4 coffee dispensing spout, 5 coffee grounds box, 6 steam nozzle, 7 water tray, 8 bean grinding assembly, 9 boiler piston assembly, 91 bag pressing mechanism, 92 coffee machine boiler, 93 piston cylinder, 94 fixing plate, 95 ejector rod mechanism, 96 piston spring, 10 waterway switching mechanism, 101 motor, 102 booster valve, 103 toggle, 104 microswitch, 105 waterway switching shell, 11 flowmeter, 12 water outlet valve, 13 electromagnetic pump.

### DETAILED DESCRIPTION OF THE EMBODIMENTS

Hereafter, the technical solutions in the embodiments of the present disclosure will be clearly and completely described, in combination with the accompanying drawings in the embodiment of the present disclosure. Apparently, the embodiments described are only a part of embodiments of the present disclosure, not all embodiments. Based on embodiments of the present disclosure, all other embodiments obtained by one of ordinary skill in the art without creative works fall within the scope of the present disclosure.

An object of the present disclosure is to provide a coffee machine, which can solve the problems existing in the prior art, simplify the brewing mechanism, and is easy to operate.

In order to make the above object, features and advantages of the present disclosure understood more apparent and readily, the present disclosure is further described in detail in combination with the accompanying drawings and detailed embodiments.

### Example 1

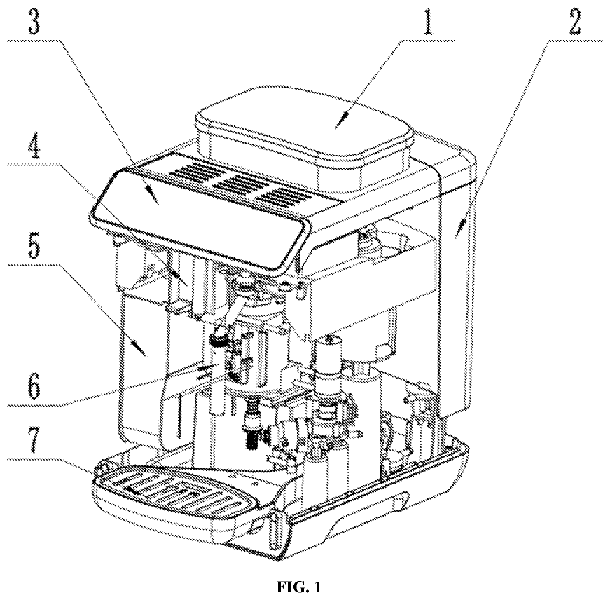

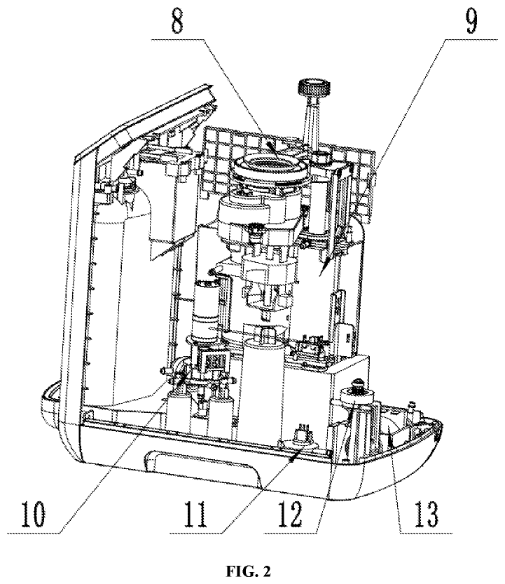

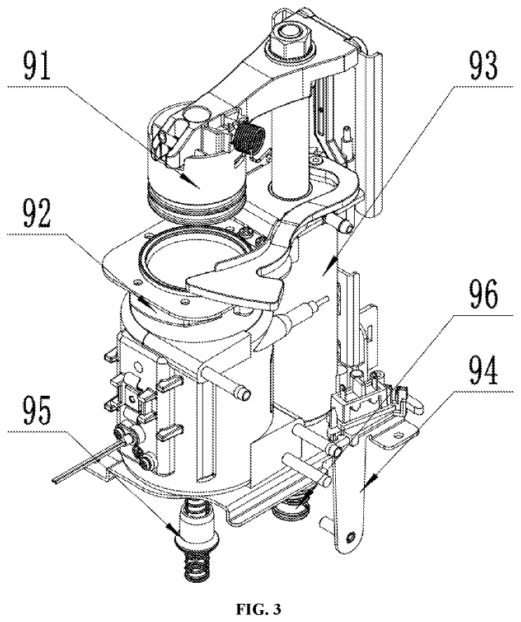

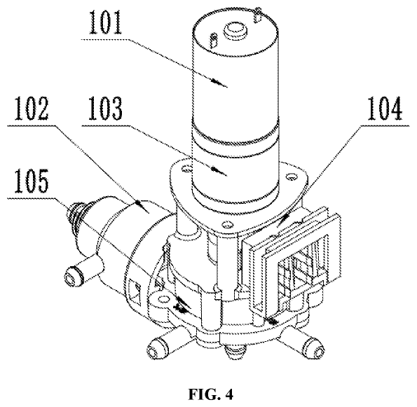

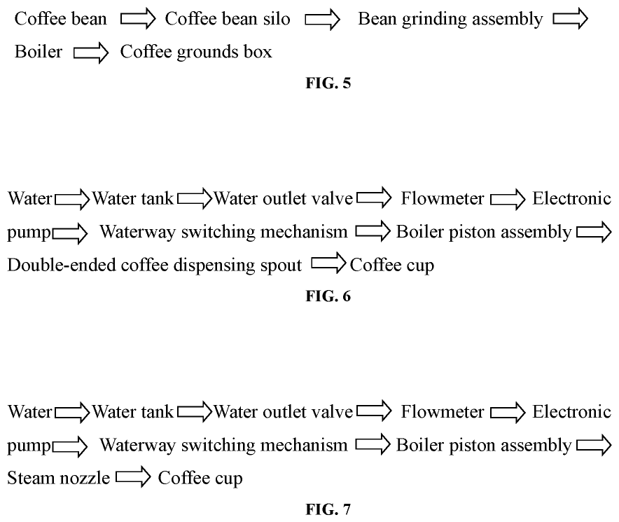

As shown in FIGS. 1-7, the present embodiment provides a coffee machine, including a main housing, the main housing is therein provided with a coffee bean silo 1, a bean grinding assembly 8, a boiler piston assembly 9, a coffee grounds box 5, a water tank 2, a waterway switching mechanism 10, and a coffee dispensing spout 4. Among them, the coffee bean silo 1 is used to temporarily store coffee beans. The coffee bean silo 1 is located at a top of the main housing, the top of the coffee bean silo 1 is provided with an exposed bean inlet for adding coffee beans therein. The bean inlet is provided with an openable top cover, and a bottom of the coffee bean silo 1 is provided with a bean outlet. The ground bean assembly 8 is located directly below the coffee bean silo 1, and is communicated with the bean outlet of the coffee bean silo 1, so that the coffee beans in the coffee bean silo 1 can fall into the bean grinding assembly 8, and grind into coffee powder through the bean grinding assembly 8. The boiler piston assembly 9 includes a coffee machine boiler 92, a bag pressing mechanism 91 and a ejector rod mechanism. The coffee machine boiler 92 is located below the bean grinding assembly 8, and can be connected with a material outlet of the bean grinding assembly 8, so that the coffee beans in the bean grinding assembly 8 can enter the coffee machine boiler 92 after having been ground into coffee powder. The bag pressing mechanism 91 includes a bag pressing block located above the coffee machine boiler 92, and the bag pressing block is connected with a piston assembly. The piston assembly can drive the pressure block to move downward into the coffee machine boiler 92, and press the coffee in the coffee machine boiler 92. The ejector rod mechanism is located at a bottom of the coffee machine boiler 92, capable of ejecting the coffee cakes in the coffee machine boiler 92 after the coffee extraction is completed, and the coffee grounds box 5 is used to receive the coffee cakes. The water tank 2 is used for temporary storage of water, and the waterway switching mechanism 10 is connected with both the coffee machine boiler 92 and the water tank 2, capable of transferring water to the coffee machine boiler 92 so as to extract coffee. The coffee dispensing spout 4 is connected to the coffee machine boiler 92, and the coffee dispensing spout 4 extends out of the main housing, and can discharge the extracted coffee, wherein the coffee dispensing spout 4 is preferably a double-ended coffee dispensing spout.

In the present example, the bean grinding assembly 8 includes a motor, a reduction gear set, a connecting shaft and a knife grinding assembly. An output shaft of the motor is connected with an input gear of the reduction gear set, and an output gear of the reduction gear set is connected with the connecting shaft. The knife grinding assembly is installed in a grinding bean cavity, including an internal grinding knife and an external grinding knife. The internal grinding knife is coaxially arranged on an inner side of the external grinding knife. A grinding gap is formed between the internal grinding knife and the external grinding knife, and the added coffee beans can enter the grinding gap. The internal grinding knife is coaxially installed on a top of the connecting shaft. After the motor is decelerated through the reduction gear set, the internal grinding knife is driven to rotate through the connecting shaft to grind the coffee beans between the internal grinding knife and the external grinding knife. A powder outlet channel is also connected at a bottom of the grinding cavity. The ground coffee powder can flow out of the powder outlet channel. Among them, it should be noted that the above structures of the bean grinding assembly 8 in this embodiment is mature existing prior art in the field and will not be repeated any longer.

In the present example, a center part of the output gear is axially provided with a shaft hole, a bottom of the connecting shaft is installed in the shaft hole and is coaxial with the output gear. The connecting shaft and the output gear are connected by a limit mechanism disposed along an axial direction of the connecting shaft. The limit mechanism can limit a relative circumferential rotation between the connecting shaft and the output gear, so that the connecting shaft can be driven to rotate synchronously by the output gear. Moreover, the limiting mechanism can allow the output gear to move axially along the connecting shaft, so that the output gear can be directly sleeve around the connecting shaft, and the assembly is simple. When the grinding bean component 8 is installed, the output gear is located between a bottom wall of the gearbox and a bottom wall of the grinding bean cavity, and the axial movement of the output gear is limited by both the gearbox and the grinding bean cavity.

In the present example, the connecting shaft and the output gear are connected by the limit mechanism disposed along the axial direction of the connecting shaft. Through the limit mechanism, the relative circumferential rotation between the connecting shaft and the output gear can be limited, and the output gear can move axially along the connecting shaft. Thus, the use of the connecting pin is eliminated, and the material cost is reduced. Moreover, it is unnecessary to process a through hole for installing the connecting pin on the connecting shaft, which reduces the processing difficulty of the connecting shaft and avoids the problem that the connecting shaft is easy to make mistakes in processing. Further, in the present example, the output gear can be directly assembled on the connecting shaft, and the assembling process is simple.

In the present example, the limit mechanism includes a first limit plane and a second limit plane, the first limit plane is set axially on the connecting shaft, the second limit plane is set axially on an inner wall of the shaft hole of the output gear, and the first limit plane and the second limit plane are snugly fitted together to limit the circumferential rotation of the connecting shaft relative to the output gear. Specifically, both the first limit plane and the second limit plane are rectangular planes, so that the shaft hole in the output gear forms a D-shaped hole, and the connecting shaft is a corresponding D-shaped shaft. The output gear can drive the connecting shaft to rotate synchronously by the matching of the D-shaped shaft with D-shaped hole, and the D-shaped shaft can be integrally formed and processed, and is simple to process. Moreover, the force areas of the output gear and the connecting shaft are increased through force acting on the rectangular planes, and the output gear is uniformly stressed, and the structure is more optimized. It should be noted that a height of the rectangular plane is the same as a depth of the shaft hole of the output gear, that is, only the part of the connecting shaft installed in the output gear is D-shaped shaft, and other parts can still be cylindrical, while the shaft hole of the output gear is a D-shaped hole as a whole.

In addition, one of ordinary skill in the art should understand that the torque transmission between the output gear and the connecting shaft can be achieved as long as a cross section of a place of the connecting shaft connected to the output gear is processed into a non-circular shape (i.e. a polygon), and the corresponding shaft hole of the output gear is processed into an adaptive shape.

Alternatively, in the present example, the limit mechanism can include a limit slot and a limit key, which can realize the synchronous rotation of the connecting shaft driven by the output gear by the cooperation of the limit slot and the limit key.

Specifically, the connecting shaft is provided with a limit key in the axial direction, the inner wall of the shaft hole of the output gear is provided with a limit slot in the axial direction, and the limit key can be snap-fitted into the limit slot to limit the circumferential rotation of the connecting shaft relative to the output gear.

Alternatively, the connecting shaft is provided with a limit slot in the axial direction, while the inner wall of the shaft hole of the output gear is provided with a limit key in the axial direction, and the limit key can be snap-fitted into the limit slot to limit the circumferential rotation of the connecting shaft relative to the output gear.

The length of both the limit slot and the limit key is the same as the depth of the shaft hole of the output gear. Moreover, whether the limit slot or the limit key is set on the connecting shaft, the connecting shaft can be integrally formed and processed, reducing the processing difficulty.

In the present example, the reduction gear set is installed in the gearbox, and the gearbox is located under the grinding cavity. The reduction gear set is a mature prior art in the art, and will not be repeated in present embodiment, for example, the reduction gear set may be a planetary reduction gear set or other types of reduction gear.

As an embodiment, in the present example the reduction gear set includes a first gear and a second gear. The first gear is used as an input gear, the output shaft of the motor is connected with a drive gear, the drive gear and the input gear are meshed with each other, wherein a diameter of the input gear is larger than that of the drive gear to achieve deceleration. The second gear is used as the output gear and meshed with the first gear, and a diameter of the second gear is larger than that of the drive gear, and the connecting shaft is installed in the shaft hole in a center of the second gear. Alternatively, a connecting gear can be coaxially mounted on an axle of the first gear, a diameter of the connecting gear is smaller than those of both the first gear and the second gear, and the second gear is meshed with the connecting gear to achieve deceleration.

Alternatively, the reduction gear set only includes the first gear and the drive gear, the drive gear is connected to the output shaft of the motor, and meshed with the first gear, the diameter of the first gear is larger than that of the drive gear to achieve deceleration, and the connecting shaft is installed in the shaft hole in the center of the first gear.

In the present example, a bottom end of the connecting shaft is rotatably installed at a bottom of the gearbox, a top end of the connecting shaft is passed through the bottom of the grinding cavity and is connected to the inner grinding knife, and the connecting shaft is rotatably connected to the bottom of the grinding cavity. Among them, the bottom end of the connecting shaft is rotatably installed on the bottom of the gearbox through a first bearing, and the connecting shaft is rotatably connected to the bottom of the grinding cavity through a second bearing. Further, the connection of the connecting shaft with the grinding cavity is provided with a sealing ring to prevent the coffee powder in the grinding cavity from entering the gearbox.

In the present example, the inner grinding knife is preferably a conical grinding knife, and the conical grinding knife is gradually reduced in diameter from bottom to top, and the external grinding knife is preferably an annular grinding knife. A top of the grinding chamber is also provided with a particle size adjuster, which is connected to the inner grinding knife or the external grinding knife, can adjust the size of the grinding gap between the inner grinding knife and the external grinding knife, so that particle sizes of the ground coffee powder can be adjusted.

Among them, it should be noted that the particle size adjuster is a mature prior art in the field, and will not be repeated in this embodiment. For example, the particle size adjuster can be connected with the external grinding knife, and the external grinding knife is connected with a side wall thread of the grinding cavity, and the external grinding knife is driven to rotate through the particle size adjuster, so that the external grinding knife can be driven to move up and down in the grinding cavity, and in turn, the size of the grinding gap between the internal grinding knife and the external grinding knife can be adjusted. Alternatively, a connecting block can be provided at a top of the inner grinding knife, and the particle size adjuster can be connected to the internal grinding knife through the connecting block, and the internal grinding knife is threaded to the connecting shaft. And the internal grinding knife can be driven to rotate through the particle size adjuster, so that the internal grinding knife can be driven to move up and down on the connecting shaft, and in turn, the size of the grinding gap between the internal grinding knife and the external grinding knife can be adjusted.

Further, the particle size adjuster can be selected according to the working needs, such as selecting knobs or rotating rings.

A working process of the grinding bean component 8 in this embodiment is as follows:

First, the coffee beans slide into the grinding gap between the inner grinding knife and the outer grinding knife due to gravity.

Second, the motor is energized and rotated, and the internal grinding knife is driven to rotate after deceleration by the reduction gear set, and the coffee beans are turned into the required coffee powder through the friction and extrusion of the internal grinding knife and the external grinding knife.

Third, the coffee powder can be allowed to flow out of the powder channel. The coffee powder can flow down from the powder channel by gravity, or a powder shifter can also be arranged to push the coffee powder to the powder channel. The powder shifter is a mature prior art in the art, and will not be repeated in the present example.

In the present example, the coffee machine boiler 92 includes a pot body and a coffee powder silo which are arranged separately. The pot body is a die-casting molded pot body. A top of the pot body is provided with an installation cavity, the coffee powder silo is installed in the installation cavity, and the coffee powder silo is fixedly connected to the pot body by a fastener. The pot body is therein provided with a heating device and a hot water pipe, wherein the heating device is capable of heating so that the pot body is stable within a required temperature range. The hot water pipe is connected to the coffee powder silo for providing hot water to the coffee powder silo. And the connection between the hot water pipe and the coffee powder silo is provided with a sealer.

In the present example, the coffee powder silo and the pot body are separately disposed, in the meanwhile the coffee powder silo and the hot water pipe are no longer welded together, but the coffee powder silo and the pot body are fixedly connected by the fastener, and a sealer is provided between the coffee powder silo and the hot water pipe to achieve a sealing leak-proof effect. The structure is simple to assemble, which avoids problems of difficult welding and easy leakage of the coffee powder silo and the hot water pipe. Moreover, in the present embodiment, the coffee powder silo and the pot body are separately disposed, and the pot body can be die-casting molded separately, making the die casting process simple, improving the efficiency of die casting, reducing the cost of die casting, and avoiding problems such as cracking at the welding caused by die casting in the prior art.

In the present example, the mounting cavity is a cylindrical cavity, and the coffee powder silo is a cylindrical coffee powder silo matched with the installation cavity. Alternatively, other shapes of the installation chamber and coffee powder silo, such as square or other polygons, can be selected according to the working needs.

In the present example, the fastener is a fixing bolt. Specifically, an annular mounting platform is arranged around a top outer periphery of the pot body, and an annular boss is arranged around a top outer periphery of the coffee powder silo. The annular boss is overlapped on the annular mounting platform. The annular boss and the annular mounting platforms are correspondingly provided with bolt holes. The annular boss and the annular mounting platform are fixedly connected by fixing bolts through the bolt holes.

Further, the fastener can be also selected other fixing structures according to the working needs, such as a snap-fit fixing structure, or a fixing structure with a snap-fit and a bolt cooperative with each other.

In the present example, the heating device is a heating tube, which is energized electrically to generate heat. Alternatively, heating devices such as electric heating wire or heating rod can be selected according to specific work needs.

In the present example, the sealer is a sealing ring, preferably a rubber or silicone sealing ring; alternatively, hemp thread or sealing tape can be selected for sealing as required.

In the present example, the pot body is also provided with a steam pipe therein, and an outlet of the steam pipe is used to connect with a steam nozzle 6 to provide steam.

In the present example, both the steam pipe and the hot water pipe are connected with a water inlet pipe respectively. Each water inlet pipe is installed with a booster pump to provide pressurized water for the steam pipe or the hot water pipe by the booster pump.

The specific working process of the coffee machine boiler 92 in the present example is as follows.

First, when making coffee, the heating pipe is energized electrically for heating, so that the pot body is stabilized within the required temperature range. The pressurized water enters from the hot water pipe, then flows into the coffee powder silo to fully contact with the coffee powder, making coffee, and then the brewed coffee flows out from the bag pressing mechanism 91 above the coffee powder silo. Among them, the pressing mechanism 91 is the existing mature technology, which will not be repeated in the present example.

Second, when steam is applied, the heating pipe is energized electrically for heating, so that the pot body is stabilized within the required temperature range. Pressurized water enters from the steam pipe, becomes steam through being heated and pressure action, and then is ejected from the steam nozzle 6.

Furthermore, a temperature sensor can be arranged in the pot body to monitor the temperature, so as to ensure that the heating temperature reaches the required temperature range.

In the present example, the ejector rod mechanism 95 includes an ejector head and a base. The ejector head can stretch into the bottom of the coffee powder silo. A bottom of the ejector head is connected with the base through a linkage mechanism, and the linkage mechanism can drive the ejector head to move up and down, so as to eject the coffee cake out of the coffee powder silo after the coffee machine completes the coffee cake pressing action. The linkage mechanism is sleeved with a sleeve, a top of the sleeve gets stuck at the bottom of the coffee powder silo, and a first elastic element is arranged between a bottom of the sleeve and a top of the base. The linkage mechanism is a connecting rod formed integrally.

In the present example, the linkage mechanism is a connecting rod formed integrally, which replaces the previous linkage mechanism which includes stainless steel outer tube, aluminum core tube and O-ring. It has a simple structure, and avoids the problems of easy interference between parts, poor sealing and difficult assembly; moreover, it also reduces the number of parts, which can decrease the material cost and manufacturing cost of products.

In the present example, a top of the connecting rod is connected with the ejector head through bolts, and a bottom of the connecting rod is connected with the base through bolts.

In the present example, the connecting rod is a solid stainless-steel rod; alternatively, the connecting rod is a hollow stainless-steel pipe.

In the present example, the sleeve has and is provided with only one. Compared with two sleeves in the prior art, the product structure is optimized, and the assembly cost of the product is lowered.

In the present example, the bottom of the sleeve is provided with a first snap-fitting groove, the top of the base is provided with a second snap-fitting groove, and a top and a bottom of the first elastic element are respectively snap-fitted into the first snap-fitting groove and the second snap-fitting groove.

In the present example, the bottom of the base is provided with a second elastic element. In an initial state, the connecting rod is raised up through the second elastic element, so that the ejector head can be pushed up. At this time, the ejector head can be used as the bottom of the coffee powder silo to receive coffee powder; and then is pressed down by the bag pressing mechanism to perform the bag pressing action, at this time, the ejector head is moved downward and the second elastic element is compressed. When brewing of the bag pressing is completed, the bag pressing mechanism rises, and the second elastic element pushes the ejector head upward to reset through the connecting rod, so as to eject the coffee cake. A bottom of the second elastic element can be supported on a bracket arranged in the main housing.

It should be noted that in the present example, both the first elastic element and the second elastic element are preferably springs, and alternatively, elastic diaphragms or bellows can also be selected.

Alternatively, the connecting rod can be connected with a driving mechanism, such as a hydraulic cylinder or a linear motor, so that the connecting rod is driven to move up and down through the driving mechanism. In the initial state, the ejector head is located at the bottom of the coffee powder silo, and then the coffee powder is put into the coffee powder silo, and then the bag pressing mechanism presses down to perform the bag pressing action. When the brewing of the bag pressing is completed, the bag pressing mechanism will rise up, and the driving mechanism will push the ejector head upward through the connecting rod to eject the coffee cake.

In the present example, the piston assembly includes a piston cylinder, in which a piston is arranged. The piston is slidingly sealed with the piston cylinder. A pressure chamber is formed in a space in the piston cylinder above the piston, a water inlet and a water outlet are arranged on the pressure chamber. A top of the piston is connected with a piston rod, and the piston rod is extended upward out of the piston cylinder and is connected with the bag pressing block. A bottom of the piston is connected with a piston spring, wherein the piston rod is slidingly sealed with a top of the piston cylinder. Water is supplied to the pressure chamber through the water inlet of the pressure chamber, and can push the piston to compress the piston spring to move downward, so that the piston rod can drive the bag pressing block to move downward to achieve bag pressing. When the bag pressing is completed, the water in the pressure chamber is discharged through the water outlet, and the piston spring can push the piston to move upward, so that the piston rod can drive the bag pressing block to move upward to achieve reset.

In the present example, the waterway switching mechanism 10 includes a waterway switching shell 105, on which a group of waterway connectors are arranged. The waterway connectors include a waterway connector for piston, a waterway connector for returning water, and a waterway connector for boiler. Among them, the waterway connector for piston is communicated with the water inlet of the pressure chamber of the piston assembly, and is used to pass water into the pressure chamber of the piston assembly of the coffee machine, to drive the piston assembly to complete the bag pressing action on coffee. The waterway connector for returning water is communicated with the water outlet of the pressure chamber of the piston assembly, and is used to return the water in the piston assembly to the waterway switching shell 105. And the waterway connector for boiler is used to pass water into the coffee machine boiler 92 to extract coffee. The waterway switching shell 105 is also connected with a water intake for passing water into the waterway switching shell 105. The waterway switching shell 105 is also installed with a waterway switching assembly for switching different waterway connectors. Among them, the piston assembly and the coffee machine boiler 92 are both basic components in the coffee machine, which are mature prior art in the field, and will not be repeated in detail.

In the present example, only one group of waterway connectors are set on the waterway switching shell 105, and the waterway connectors include the waterway connector for piston, the waterway connector for returning water, and the waterway connector for boiler. Compared with the prior art of two groups of waterway connectors totaling seven waterway connectors, the present example reduces the amount of waterway connectors, simplifies the waterways, effectively avoids winding of the waterways, and decreases the difficulty of assembly; and also, since only one group of waterway connectors is set, only one waterway switching assembly can be provided to reduce the amount of parts and cost.

In the present example, each of the waterway connectors is equipped with a corresponding waterway identification, which is convenient to distinguish each waterway connector and avoid assembly errors. Further, the waterway identification is preferably arranged on the waterway switching shell 105 and close to the corresponding waterway connector, and alternatively the waterway identification can also be directly arranged on the waterway connector.

In the present example, the waterway switching mechanism 10 of the coffee machine includes a microswitch 104, and the microswitch 104 is installed on the waterway switching shell 105. The waterway switching assembly is controlled by the microswitch 104 to realize the switching of different waterway connectors. Specifically, the microswitch 104 is mounted on the waterway switching shell 105 through a switch bracket, the switch bracket is tightly locked and fixed with the waterway switching shell 105 by screws, wherein the switch bracket can seal a top opening of the waterway switching shell 105, while the microswitch 104 is installed, because only one group of waterway connectors and one waterway switching assembly are provided, the cross-sectional areas of both the waterway switching shell 105 and the switch bracket are small, and the both are locked tightly and fixed only by four screws set at the peripheral thereof. Compared with the prior art that two groups of waterway connectors are provided, and the top opening of the waterway switching shell 105 needs to be added with a top cover plate for sealing, and the top cover plate needs to be tightly locked and fixed with the waterway switching shell 105 through seven screws, the present example reduces the amount of parts, decreases the difficulty of assembly and the cost of parts; moreover, in the present example, only one group of waterway connectors is provided, and the tight locking and fixing between the components can be realized only by screws, avoiding the complex process of ultrasonic welding required by two groups of waterway connectors in the prior art, decreasing the difficulty of assembly and process difficulty, and avoids functional problems such as water leakage of products caused by overly complex processes.

In the present example, the microswitch 104 may not be installed on the waterway switching shell 105, at this time, the top opening of the waterway switching shell 105 can be provided with a top cover for sealing.

In the present example, the waterway switching assembly includes a toggle head, a propeller shaft, a first ceramic sheet, a second ceramic sheet and a third ceramic sheet arranged sequentially from top to bottom, wherein the toggle head extends upward beyond the switch bracket and is connected to the drive mechanism through the toggle 103, and a sealing gasket may be provided between the toggle head and the switch bracket for sealing. Among them, the drive mechanism is connected with the microswitch 104, and the driving mechanism can be selected according to the working needs, such as selecting the drive motor or motor 101, etc. The drive mechanism switch is controlled through the microswitch 104 to drive the waterway switching assembly to rotate so as to realize switching of the waterway. Further, the drive mechanism is connected to the toggle 103 via a gear reduction box.

In the present example, the water intake is connected with a booster valve 102 to form a booster pump structure, wherein the booster valve 102 is a mature prior art in the art, which can be selected according to specific work needs. Specifically, as an embodiment, the booster valve 102 may include a booster valve housing, the booster valve housing is therein provided with a chamber, and the booster valve housing is provided with a water port, the water port is connected to the water intake of the waterway switching shell through the inside chamber of the booster valve housing. And the booster valve housing is also therein provided with springs, inner shafts, sealing plugs and sealing sleeves, etc.

Among them, the sealing sleeve is installed in the booster valve housing, is a conical sealing sleeve, gradually increases in diameter in a direction of water flow from the booster valve to the waterway switching shell. An outer periphery of the sealing sleeve is sealingly connected with an inner wall of the booster valve housing, and an axial through hole is provided in a center thereof. An inner shaft is installed in the axial through hole, and is movable along the axial through hole. The inner shaft is provided with a limit boss at an end thereof near the water port of the booster valve housing, the limit boss is located between a larger-opening end and a smaller-opening end of the sealing sleeve, and has a diameter greater than that of the smaller-opening end of the sealing sleeve, which can seal the smaller-opening end and prevent the inner shaft from detaching from the smaller-opening end of the sealing sleeve. And also, the above spring is provided between an end of the inner shaft away from the smaller-opening end of the sealing sleeve and the booster valve housing. When the water flow enters the booster valve housing and reaches a certain pressure, the inner shaft can be pushed to compress the spring and moved in a direction from the smaller-opening end to the larger-opening end of the sealing sleeve, so that the water flow passes through a gap between the inner shaft and the inner wall of the sealing sleeve, so as to realize the pressurization of the water flow and make the water flow into the waterway switching shell. Further, a sealing plug is installed at an end part of the inner shaft near the water inlet of the booster valve housing, and a snap-fitting location or limit structure is provided between the inner shaft and the sealing plug for fixation.

In the present example, the booster valve housing and the waterway switching shell are tightened by a rotation of the snap-fitting location connection, and the booster valve housing is sealingly connected with the waterway switching shell through an O-ring seal.

Alternatively, other types or configurations of booster valves can be selected according to the working needs, such as cam booster valves or piston booster valves.

In the present example, the pot body is further therein provided with a steam pipe, an exit of the steam pipe is connected to the steam nozzle 6, and the steam nozzle 6 is provided close to the coffee dispensing spout 4. The waterway connectors of the waterway switching mechanism 10 further include a steam waterway connector which is connected to the steam pipe.

In the present example, the water tank 2 is connected to the water inlet of the waterway switching shell 105 through the water inlet pipe, the water inlet pipe is provided with an electromagnetic pump 13 and a flowmeter 11, and the flowmeter 11 is connected to a control mechanism.

In the present example, the control mechanism is a control panel 3, the control panel 3 is installed on a top of a front side of the main housing. The control panel 3 is provided with a cup volume button for controlling a water output, which can meet cup volume requirements of various customers. Moreover, by means of a preset program, the grinding time can be controlled, and the amount of coffee powder can be controlled, and even if the user chooses a large cup amount, mellow coffee is available. Of course, for users with different needs, the concentration of coffee is selectable.

In the present example, the main housing is further provided with a water receiving tray 7 at a bottom of the front side thereof, and the water receiving tray 7 is located below the coffee dispensing spout 4.

The specific working process of the coffee machine when brewing coffee in the present example is as follows:

Preparation before working:

An appropriate amount of coffee beans is put in the coffee bean silo 1, and an appropriate amount of water is filled into the water tank 2, and a coffee cup is placed on a drip tray.

The coffee machine is energized electrically to preheat, and after the preheating, an appropriate cup volume and a coffee concentration are selected, and then brewing coffee is started.

The coffee beans enter the bean grinding assembly 8 along the bean outlet of the coffee bean silo 1, and the bean grinding assembly 8 grinds the coffee beans into coffee powder through an internal grinding knife and an external grinding knife, and the coffee powder slides into a middle of the coffee machine boiler 92.

The water in the water tank 2 is delivered to the booster pump by an electromagnetic pump 13, and a part of the water flows into a piston assembly to complete the bad pressing action. After the bad pressing action is completed, the booster pump is rotated to pump the pressurized water into the coffee pipeline in the coffee machine boiler 92, and heating and extracting coffee is started, and the extracted coffee flows to the double-ended coffee dispensing spout, and then flows into the coffee cup.

After the coffee extraction is completed, the water will be returned by the booster pump assembly, the coffee cake in the coffee machine boiler 92 is ejected, and is pushed into the coffee grounds box 5 through a shifting lever, and the coffee brewing process is complete.

The specific working process of the coffee machine in this example is as follows:

The water in the water tank 2 is delivered to the booster pump by the electromagnetic pump 13, and the booster pump is rotated to pump the pressurized water into the steam pipeline in the boiler, and after heating, the steam is sprayed out from the steam nozzle 6 to the coffee cup.

It should be noted that for one of ordinary skill in the art, it is obvious that the present disclosure is not limited to the details of the above exemplary embodiments, and without deviating from the spirit or basic characteristics of the present disclosure, the present disclosure can be realized in other specific forms. Accordingly, from any point of view, the examples and embodiments should be regarded as exemplary and non-restrictive. The scope of the present disclosure is limited only by the appended claims rather than the above description, so it is intended to include all variations falling within the meaning and scope of the equivalent elements of the claims, and any drawing sign in the claims should not be regarded as limiting the claims involved.

The principle and embodiment of the present disclosure are described by means of specific examples of the present disclosure, and the illustration of the above embodiments is only used to help understand the method and its core ideas of the present disclosure. At the same time, for one of ordinary skill in the art, according to the ideas of the present disclosure, there would be changes in the specific embodiments and application ranges thereof. In summary, the contents of this specification should not be understood as a restriction on the present disclosure.

What is claimed is:

1. A coffee machine, comprising a main housing, wherein the main housing has therein:
a coffee bean silo arranged for temporary storage of coffee beans;
a bean grinding assembly for grinding the coffee beans, wherein the bean grinding assembly is connected with a bean outlet of the coffee bean silo;
a boiler piston assembly comprising a coffee machine boiler, a bag pressing mechanism and an ejector mechanism, wherein the coffee machine boiler can be connected with a material outlet of the bean grinding assembly, and the coffee beans in the bean grinding assembly can enter the coffee machine boiler after having been ground, wherein the bag pressing mechanism comprises a bag pressing block which is connected with a piston assembly, wherein the piston assembly can drive the bag pressing block to perform bag pressing on coffee in the coffee machine boiler, and wherein the ejector mechanism can eject a coffee cake in the coffee machine boiler after a coffee extraction is completed;
a coffee grounds box for receiving the coffee cake;
a water tank for temporary storage of water;
a waterway switching mechanism which is connected with both the coffee machine boiler and the water tank, and can deliver water to the coffee machine boiler to extract the coffee;
a coffee dispensing spout which is connected with the coffee machine boiler, and extends out of the main housing.

2. The coffee machine according to claim 1, wherein the bean grinding assembly comprises a motor, a reduction gear set, a connecting shaft and a knife grinding assembly, an output shaft of the motor is connected with an input gear of the reduction gear set, an output gear of the reduction gear set is connected with the connecting shaft, the knife grinding assembly is installed in the bean grinder cavity, and the knife grinding assembly comprises an internal grinding knife and an external grinding knife, the internal grinding knife is coaxially mounted on a top of the connecting shaft, and a grinding gap is formed between the internal grinding knife and the external grinding knife, a shaft hole is arranged in a center of the output gear, and a bottom of the connecting shaft is installed in the shaft hole and is coaxial with the output gear, the connecting shaft and the output gear are connected by a limit mechanism arranged in an axial direction of the connecting shaft, and the limit mechanism can limit a relative circumferential rotation between the connecting shaft and the output gear and allow the output gear to move axially along the connecting shaft.

3. The coffee machine according to claim 1, wherein the coffee machine boiler comprises a pot body and a coffee powder silo which are arranged separately, an installing cavity is arranged at a top of the pot body, the coffee powder silo is installed in the installation cavity, the coffee powder silo is fixedly connected with the pot body through a fastener, the pot body is therein provided with a heating device and a hot water pipe, and the hot water pipe is connected with the coffee powder silo for providing hot water to the coffee powder silo, and a connection between the hot water pipe and the coffee powder silo is provided with a sealer.

4. The coffee machine according to claim 3, wherein the ejector mechanism comprises an ejector head and a base, the ejector head can extend into a bottom of the coffee powder silo, a bottom of the ejector head is connected with the base through a linkage mechanism; and the linkage mechanism is sleeved with a sleeve, a top of the sleeve gets stuck at the bottom of the coffee powder silo, a first elastic element is arranged between a bottom of the sleeve and a top of the base, and the linkage mechanism is a connecting rod formed integrally.

5. The coffee machine according to claim 4, wherein the piston assembly comprises a piston cylinder in which a piston is arranged, and the piston is slidingly sealed with the piston cylinder, a pressure chamber is formed above the piston, the pressure chamber is provided with a water inlet and a water outlet, a top of the piston is connected with a piston rod which is extended upward out of the piston cylinder and connected with the bag pressing block, and a bottom of the piston is connected with a piston spring, wherein the piston rod is slidingly sealed with a top of the piston cylinder.

6. The coffee machine according to claim 5, wherein the waterway switching mechanism comprises a waterway switching shell, on which a group of waterway connectors are arranged, and the waterway connectors comprise a waterway connector for piston, a waterway connector for returning water and a waterway connector for boiler, wherein the waterway connector for piston is used to pass water to the piston assembly to complete the bag pressing action, the water connector for returning water is used to return water in the piston assembly return to the waterway switching shell, the waterway connector for boiler is used to pass water to the coffee machine boiler to extract coffee; and the waterway switching shell is also connected with a water intake for connecting with the water tank, and a booster valve is provided at the water intake, and the waterway switching shell is also installed with a waterway switching assembly for switching different waterway connectors.

7. The coffee machine according to claim 6, wherein the pot body is further therein provided with a steam pipe, an exit of the steam pipe is connected with a steam nozzle, and the steam nozzle is provided close to the coffee dispensing spout; and the water connectors of the waterway switching mechanism also comprise a steam waterway connector which is connected with the steam pipe.

8. The coffee machine according to claim 6, wherein the water tank is connected with the water intake of the waterway switching shell through a water inlet pipe, and the water inlet pipe is provided with an electromagnetic pump and a flowmeter, and the flowmeter is connected with a control mechanism.

9. The coffee machine according to claim 8, wherein the control mechanism is a control panel, which is installed on a top of a front side of the main housing and provided with a cup volume button for controlling water output.

10. The coffee machine according to claim 1, wherein the main housing is also provided with a water receiving tray at a bottom of the front side thereof, and the water receiving tray is located below the coffee dispensing spout.
